(19) United States
(12) Patent Application Publication
(10) Pub. No.: US 2022/0136561 A1
(43) Pub. Date: May 5, 2022

(54) WEAR RESISTANT, HIGHLY THERMALLY CONDUCTIVE SINTERED ALLOY

(71) Applicant: Mahle International GmbH, Stuttgart (DE)

(72) Inventors: Andreas Gutmann, Zell im Wiesental (DE); Lilia Kurmanaeva, Schopfheim (DE); Patrick Sutter, Schopfheim (DE); Klaus Wintrich, Schopfheim (DE); Alexander Puck, Esslingen (DE)

(21) Appl. No.: 17/513,878

(22) Filed: Oct. 28, 2021

(30) Foreign Application Priority Data
Oct. 29, 2020 (DE) 102020213651.3

(51) Int. Cl. F16C 33/12; C22C 9/04; C22C 1/05; C22C 1/04; F16C 17/02

(52) U.S. Cl. CPC F16C 33/12; C22C 9/04; F16C 2220/20; C22C 1/0425; F16C 17/02; C22C 1/051

(57) ABSTRACT

A powder metallurgically produced, wear-resistant, and highly thermally conductive copper-based sintered alloy as matrix is disclosed. The sintered alloy includes a powder mixture of a copper-base powder, of a hard phase with a total share of 8 to 40% by weight, of a solid lubricant with a total share of 0.4 to 3.8% by weight, of a pressing additive with a total share of 0.3 to 1.5% by weight, and production-related impurities. The powder mixture includes at least 55% by weight of the copper-base powder.

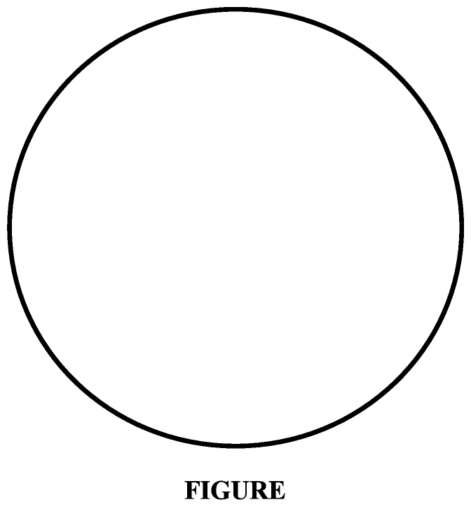

### CROSS-REFERENCE TO RELATED APPLICATIONS

This application claims priority to German Application No. DE 10 2020 213 651.3 filed on Oct. 29, 2020, the contents of which are hereby incorporated by reference in its entirety.

### TECHNICAL FIELD

The invention relates to a powder metallurgically produced, wear-resistant and highly thermally conductive copper-based sintered alloy as matrix, in particular for bearing applications and valve seat rings, wherein the sintered alloy is a powder mixture of a copper-base powder, of a hard phase, of a solid lubricant, and of a pressing additive. The invention also relates to the production and the use of a wear-resistant and highly thermally conductive copper-based sintered alloy as matrix.

### BACKGROUND

A large variety of materials, i.e. so-called bearing metals, are currently used for sintered alloys in order to produce bearings, for example slide bearings, but also for valve seat rings. Bearing metals should have a high strength and resistance and should have as little frictional resistance as possible, so that they heat up and wear sparsely. The alloying metals as well as the proportions thereof are to be varied as a function of the property, which is to be prioritized, for the respective application.

Sintered alloys of steel powders, the sinter porosity of which is impregnated with oil and/or which contain solid lubricants, for above-mentioned applications are known in the prior art. It is a disadvantage of these sintered alloys for the production of bearings or valve seat rings that reverse rotors, which may be present, generally require a coating. Generic alloys additionally increasingly reach their limits, in particular due to the increased temperatures in the newer combustion engines, because the strength decreases sharply with the temperature in the case of these alloys.

Valve seat rings, i.e. rings arranged at the openings of the inlet and outlet channels of the cylinder heads, are not only subjected to the hammering effect of the valves, but are also influenced by the hot explosive gases. This means that a high thermal conductivity with simultaneously high wear resistance is usually required thereby.

Brass or bronze alloys are thus used in particular for valve seat rings, because pure copper is not suitable as bearing metal due to the low strength and high ductility. Further copper alloys, which have the required hardness and strength as well as thermal conductivity, are, for example, copper-beryllium alloys. However, beryllium has the disadvantage that this metal is highly toxic and that high safety standards have to be adhered to during the production.

To increase the thermal conductivity in the case of valve seat rings, it is known to provide them as sintered molded parts. The valve seat rings are thereby often infiltrated with copper during the sintering process and thus reach a higher thermal conductivity.

Layer-sintered valve seat rings are used as well. For this purpose, a valve seat ring of a wear-resistant material in the contact region to the valve and of a material with a high thermal conductivity in the remaining region is combined. However, a desired reductions of the valve temperature is only attained insignificantly thereby. Only reduction of approximately 3K were calculated in simulations, a reduction of the component temperatures at the valve during engine tests was not determined thereby compared to conventional valve seat rings.

A copper-based multi-layer sintered slide element is known from EP 1 975 260 A1, which comprises 0.5 to 20% by weight of tin, 0.1 to 35% by weight of manganese, 2 to 25% by weight of a solid lubricant, and copper as the remainder. Sintered slide elements of this type have sliding properties, which are similar to or higher than those of copper-based lead-containing sintered slide elements.

A powder metallurgically produced valve seat ring is known from DE 10 2016 109 539 A1, in the case of which the carrier layer consists of a solidified copper matrix, which contains 0.25 to 20% by weight of a solidified component, and the functional layer likewise consist of a solidified copper matrix, which furthermore contains 5 to 20% by weight of a hard phase.

It is a disadvantage of the above-mentioned slide elements or valve seat rings, respectively, that the production of a first layer, the so-called carrier layer has to take place initially, and the production of a second layer, the functional layer, has to take place subsequently, which by nature results in an additional method step.

Lastly, a sintered valve seat ring comprising a high valve cooling functionality and wear resistance for the use in a highly efficient motor is known from U.S. Pat. No. 10,344,636 B4. For the production, Cu powder with an average particle size of 45 μtm or less, and a purity of 99.5% or more has to be used, which by nature has a disadvantageous effect on the production costs.

### BRIEF DESCRIPTION OF THE DRAWINGS

The FIGURE shows a cross-sectional view of a bearing or a valve seat ring.

### DETAILED DESCRIPTION

It is the object of the present invention to provide a wear-resistant and highly thermally conductive sintered alloy, in particular for valve seat rings and bearing applications, which meets the usual requirements on tightness, dimensional stability, and wear resistance.

The object is solved by a powder metallurgically produced, wear-resistant, and highly thermally conductive copper-based sintered alloy as matrix, wherein the sintered alloy is a powder mixture of a copper-base powder, of a hard phase with a total share of 8 to 40% by weight of a solid lubricant with a total share of 0.4 to 3.8% by weight, and of a pressing additive with a total share of 0.3 to 1.5% by weight, as well as production-related impurities, characterized in that the powder mixture includes at least 55% by weight, preferably at least 65% by weight, and particularly preferably at least 70% by weight of copper-base powder.

Amide wax or stearate are preferably used as pressing additive with a total share of 0.3 to 1.5% by weight.

The advantages attained with the invention are in particular that the properties of copper-base materials with respect to the thermal conductivity are combined according to the invention with the properties of known valve seat ring materials of powder metallurgically produced sintered alloy with respect to a high wear resistance by means of the powder mixture. Further powder components, which increase the strength, the resistance to heat, or wear resistance, can be added in an advantageous manner.

Surprisingly, a valve seat ring, which is produced by means of a sintered alloy according to the invention, showed an improvement of the heat dissipation from the valve into the cylinder head as well as an improved heat distribution within the components. For a further increase of the heat dissipation, a hollow valve with sodium filling and/or a material with higher resistance to heat can additionally be used.

The production of the sintered alloy takes place by means of a uniaxial compacting of the powder mixture into a green body, which is subsequently sintered at a temperature of 850-1,050° C. at a sintering atmosphere of a mixture of hydrogen and nitrogen and/or endothermic gas. Endothermic gas (endogas) is a mixture of carbon monoxide (CO, approx. 20% by volume), hydrogen (H2, approximately 40% by volume), carbon dioxide (CO2, approximately 0.3% by volume), and nitrogen.

An advantageous design of the invention is specified in patent claim 2. The further development according to patent claim 2 makes it possible to increase the wear resistance. For this purpose, the hard phase preferably includes one or several alloys, which are known from the prior art (see Tribology Letters, Springer Verlag 2009), selected from the group of Fe—Mo, Fe—Mo—Si—Cr and/or Fe—Mo—Si—Cr—Ni—Mn, as well as production-related impurities. The wear resistance can in particular be increased by means of molybdenum, the resistance to heat can be increased by means of chromium, and the tensile strength can be increased by means of manganese.

A further advantageous design of the invention is specified in patent claim 3. The further development according to patent claim 3 makes it possible to reduce the friction. For this purpose, the solid lubricant includes one or several lubricants, selected from the group of sulfidic solid lubricants, hexagonal boron nitride, graphite, and/or calcium fluoride. The total share of the lubricant is preferably 0.4-3.8% by weight, and particularly preferably 1.5-2.5% by weight.

In a particularly preferred embodiment of the invention, the powder mixtures includes the following further elements with a proportion of 0.5 to 15% by weight of Zn, 0.5 to 12% by weight of Sn, 0.5 to 5% by weight of P, 0 to 15% by weight of Mn, 0.2 to 5% by weight of Si, 0 to 14% by weight of Al, 0.1 to 15% by weight of Ni, and 0.5 to 8% by weight of Fe, as well as production-related impurities.

The elements Zn, Sn, P, Mn, Al, Fe and Ni increase the strength of the alloy. The elements P and Mn increase in particular the tensile strength and hardness. The elements Si, Ni, and Fe increase the resistance to heat of the alloy. The elements Sn, Al, and Mn increase the corrosion and oxidation resistance.

The alloying elements Mn and Al can optionally be present up to a share of 20% by weight or 14% by weight, respectively, in order to further increase the strength of the alloy. In a further particularly preferred embodiment of the invention, the powder mixture includes at least 55% by weight, preferably at least 65% by weight, and particularly preferably at least 70% by weight, of copper powder, and the following further elements and/or alloys with a proportion of 1 to 20% by weight of Fe and/or a Fe alloy, and/or of 0 to 8% by weight of Co, and/or of 1 to 8% by weight of Mo, and/or of 0 to 5% by weight of Ni and/or an Ni alloy.

The elements Fe, Co, Mo, and Ni thereby increase the strength of the alloy. The element Mo additionally increases the wear resistance. The elements Fe, Co, and Ni increase the resistance to heat of the alloy.

The alloying elements Co and Ni can optionally be present up to a share of 8% by weight or 5% by weight, respectively, in order to further increase the resistance to heat of the alloy.

In a further particularly preferred embodiment of the invention, the powder mixture includes at least 55% by weight, preferably at least 65% by weight, and particularly preferably at least 70% by weight, of copper powder and the following further elements and/or alloys with a proportion of 1 to 20% by weight of Al and/or an Al alloy, and/or of 1 to 8% by weight of P and/or a P alloy, and/or of 1 to 20% by weight of Si and/or a Si alloy.

The elements Al and P increase the strength, the element Si increases the resistance to heat of the alloy. The element P additionally increases the tensile strength and hardness, the element Al increases the corrosion and oxidation resistance of the alloy.

In a further particularly preferred embodiment of the invention, the powder mixture includes at least 55% by weight, preferably at least 65% by weight, and particularly preferably at least 70% by weight, of copper powder, and in each case includes the following further elements with a proportion of 2 to 14% by weight of zinc oxides or tin oxides, and/or of 0.2-2% by weight of tungsten oxides, molybdenum oxides, copper oxides, and bismuth oxides.

In addition or in the alternative, the powder mixture can also include silicon nitride and/or silicon carbide of 1-14% by weight.

Zinc oxides, tin oxides, tungsten oxides, molybdenum oxides, copper oxides, and bismuth oxides increase the wear resistance and can act as solid lubricants. Silicon carbide and silicon nitride increase the wear resistance.

Individually, but also combined, the above-mentioned embodiments or the powder mixtures thereof, respectively, lead to a powder metallurgically produced, wear-resistant, and highly thermally conductive copper-based sintered alloy according to the invention as matrix.

After the sintering, the sintered component can still contain pores. This porosity is created, e.g., by means of a compaction of the powder mixture up to a relative density of usually 85-95% (and not up to a theoretical density of 100%), due to the evaporation of the pressing additive during the sintering or by means of an incomplete sintering. The residual porosity of the component can thereby be set in particular by means of the pressing/the compaction. If the porosity is communicative, the residual porosity can be impregnated with an oil in order to improve the friction behavior and thus the wear resistance of a bearing, for example slide bearing, or valve seat ring.

In the present invention, oils are understood as mineral oil-based aliphatic oils, such as the paraffinic oils, on the one hand. The term oil furthermore also comprises synthetic oils, such as, for example, silicon oils.

The share of the residual porosity can be determined, e.g., by means of a structural analysis and a measuring of the pore share by means of image analysis methods.

An advantage attained by means of the invention can in particular be seen in that a thermal conductivity of the material is increased by means of the composition of the sintered alloy according to the invention. The above-listed advantages are further improved thereby. Optimal results are attained, in particular when using the sintered alloy as valve seat ring, when said sintered alloy has a thermal conductivity of >40 W/mK. A measuring of the thermal conductivity thereby took place via the laser flash method (LFA—Laser Flash Apparatus).

The manufacture of a component, for example of a valve seat ring, according to the invention took place via the following manufacturing steps:

Production of a powder mixture of a hard phase, a solid lubricant, a pressing additive, and a copper-base powder. The copper-base powder as well as the hard phase thereby preferably consists of water-atomized powder. The bulk density of the copper-base powder preferably lies in a range of 2.4 to 3.8 g/ccm. The average particle diameter of the copper-base powder lies in the range of 25-160 μm wherein the measuring can take place by means of sieve analysis or by means of laser diffraction.

Pressing/compacting of the powder mixture or production of a green body, respectively: The pressing preferably takes place uniaxially. The pressing preferably takes place to a relative density of 85-95% of the theoretical density of the material. The determination of the density takes place here via weight and volume of the component.

Sintering of the component: The sintering of the component can take place on a conveyor furnace, in a chamber furnace, or a vacuum furnace. The sintering preferably takes place in a temperature range of 850-1,050° C. at a sintering atmosphere of a mixture of hydrogen and nitrogen or endogas. During the sintering, the maximum temperature is preferably reached for a time period of 15 to 45 minutes. An infiltration with a further copper-base powder can take place during the sintering process.

Calibrating/further pressing process: A further pressing process preferably takes place in the case of components, in the case of which the geometric requirements cannot be met (i.e. mass at the components is set within a tolerance by means of new pressing).

Heat treatment: If a precipitation hardening alloy was used as copper-base powder, a heat treatment takes place thereafter. Precipitations are formed thereby and the strength and hardness of the material increase.

The heat treatment preferably takes place at a temperature of 250-700° C. for the duration of 1-16 hours.

Oil impregnating: After the heat treatment, the components are preferably impregnated with oil. The impregnation with oil preferably takes place by means of a dipping process with a residence time of 2-20 minutes in the oil. An impregnation by means of negative pressure difference can thereby also take place for the improved control of the process.

Processing of the components: The processing of the components in regions, which do not meet the geometric requirements of the component, generally takes place by means of grinding or turning. At the components, a deburring is preferably performed by means of slide grinding process.

The production of sintered molded parts, in particular of bearings or valve seat rings, from the sintered material according to the invention takes place as follows, for example:

### Example 1 Valve Seat Ring with High Thermal Conductivity

A pure copper powder (purity >99%) and an average particle diameter of 70-160 μm is assumed here, which is mixed with 0.5% of a pressing additive, 2% of the solid lubricant MoS₂, and 35% of a Fe-base hard phase (T10), is subsequently pressed to a relative density of 93%, is sintered at a temperature of 980° C. under nitrogen-hydrogen atmosphere, is ground to the final dimension at the front surfaces and at the AD.

### Example 2 Axial Bearing in the Turbocharger

A bronze alloy with an Sn share of 10% and an average particle diameter of 60-150 μm is assumed here, which is mixed with 0.5% of a pressing additive, 2% of the solid lubricant MnS, and 20% of a Fe-base hard phase (T10), is subsequently pressed to a relative density of 93%, is sintered at a temperature of 900° C. under nitrogen-hydrogen atmosphere, is impregnated by means of oil at normal pressure, is ground to the final dimension at the front surfaces, and experiences a surface structuring by means of new pressing/embossing processes.

1. A powder metallurgically produced, wear-resistant, and highly thermally conductive copper-based sintered alloy as matrix, comprising:
a powder mixture of a copper-base powder, of a hard phase with a total share of 8 to 40% by weight, of a solid lubricant with a total share of 0.4 to 3.8% by weight, of a pressing additive with a total share of 0.3 to 1.5% by weight, and production-related impurities, wherein the powder mixture includes at least 55% by weight of the copper-base powder.

2. The sintered alloy according to claim 1, wherein the hard phase includes one or more alloys, including at least one of Fe—Mo, Fe—Mo—Si—Cr and Fe—Mo—Si—Cr—Ni—Mn, and production-related impurities.

3. The sintered alloy according to claim 1, wherein the solid lubricant includes one or more lubricants, including at least one of sulfidic solid lubricants, hexagonal boron nitride, graphite, and calcium fluoride.

4. The sintered alloy according to claim 1, wherein the powder mixture includes at least 65% by weight of the copper-base powder.

5. The sintered alloy according to claim 1, wherein the powder mixtures includes at least 70% by weight of the copper-base powder.

6. The sintered alloy according to claim 1, wherein the powder mixture includes the following further elements with a proportion of 0.5 to 15% by weight of Zn, 0.5 to 12% by weight of Sn, 0.5 to 5% by weight of P, 0 to 15% by weight of Mn, 0.2 to 5% by weight of Si, 0 to 14% by weight of Al, 0.1 to 15% by weight of Ni, and 0.5 to 8% by weight of Fe, and production-related impurities.

7. The sintered alloy according to claim 1, wherein the powder mixture further includes a proportion of at least one of the following: 1 to 20% by weight of at least one of Fe and a Fe alloy, of 1 to 8% by weight of Co, 1 to 8% by weight of Mo, and 1 to 5% by weight of at least one of Ni and an Ni alloy.

8. The sintered alloy according to claim 1, wherein the powder mixture further includes a proportion of at least one of the following: 1 to 20% by weight of at least one of Al and an Al alloy, 1 to 8% by weight of at least one of P and a P alloy, and 1 to 20% by weight of at least one of Si and a Si alloy.

9. The sintered alloy according to claim 1, wherein the powder mixture further includes a proportion of at least one of 2 to 14% by weight of zinc oxides or tin oxides, and 0.2-2% by weight of tungsten oxides, molybdenum oxides, copper oxides, and bismuth oxides.

10. The sintered alloy according to claim 1, wherein the powder mixture further includes elements with a proportion of 1 to 14% by weight of at least one of silicon nitride and silicon carbide.

11. The sintered alloy according to claim 1, wherein the sintered alloy has a residual porosity of at least 5%, and that at least 30% of a volume of the residual porosity is filled by an oil.

12. The sintered alloy according to claim 1, wherein the sintered alloy has a thermal conductivity of >40 W/mK.

13. A method for producing a sintered alloy comprising:
providing a powder mixture of a copper-base powder, of a hard phase with a total share of 8 to 40% by weight, of a solid lubricant with a total share of 0.4 to 3.8% by weight, of a pressing additive with a total share of 0.3 to 1.5% by weight, and production-related impurities, wherein the powder mixture includes at least 55% by weight of the copper-base powder; and
compacting the powder mixture into a green body uniaxially, and sintering the green body at a temperature of 850-1,050° C. and at a sintering atmosphere of a mixture of hydrogen and at least one of nitrogen and endogas.

14. The method according to claim 13, further comprising compacting or compressing the sintered alloy via a further pressing process after the sintering.

15. The method according to claim 13, further comprising subjecting the sintered alloy to a further heat treatment at a temperature of 250 to 700° C. after the sintering.

16. The method according to claim 13, further comprising infiltrating the sintered alloy with a further copper-based powder.

17. A bearing or a valve seat ring, comprising:
a sintered alloy comprising a powder mixture of a copper-base powder, of a hard phase with a total share of 8 to 40% by weight, of a solid lubricant with a total share of 0.4 to 3.8% by weight, of a pressing additive with a total share of 0.3 to 1.5% by weight, and production-related impurities, wherein the powder mixture includes at least 55% by weight of the copper-base powder.

18. The bearing or valve seat ring according to claim 17, wherein the hard phase includes one or more alloys, including at least one of Fe—Mo, Fe—Mo—Si—Cr and Fe—Mo—Si—Cr—Ni—Mn, and production-related impurities.

19. The bearing or valve seat ring according to claim 17, wherein the solid lubricant includes one or more lubricants, including at least one of sulfidic solid lubricants, hexagonal boron nitride, graphite, and calcium fluoride.

20. The bearing or valve seat ring according to claim 17, wherein the powder mixture includes at least 65% by weight of the copper-base powder.
